(19) United States
(12) Patent Application Publication
(10) Pub. No.: US 2012/0166532 A1
(43) Pub. Date: Jun. 28, 2012

(54) Contextually Relevant Affinity Prediction in a Social Networking System

(76) Inventors: Yun-Fang Juan, San Jose, CA (US); Ming Hua, Mountain View, CA (US)

(21) Appl. No.: 12/978,265

(22) Filed: Dec. 23, 2010

(51) Int. Cl. G06F 15/16

(52) U.S. Cl. 709/204

(57) ABSTRACT

A tunable affinity function serves one or more processes running in a social networking environment, where each process may request a measure of affinity for a particular user. A module that implements the affinity function computes the requested measure of affinity by combining (e.g., adding) a weighted set of predictor functions, where each predictor function predicts whether the user will perform a different action. The weights are provided by the process that requests the measure of affinity, which allows the requesting process to weight the predictor functions differently and thus tune the affinity function for its own purpose.

### BACKGROUND

This invention relates generally to social networking, and in particular to computing contextually relevant affinities for users of a social networking system by predicting different types of actions that users of the social networking system may perform.

Social networking systems allow users to designate other users as connections (or otherwise connect to or form relationships with other users), contribute and interact with media items, use applications, join groups, list and confirm attendance at events, invite connections, and perform other tasks that facilitate social interaction. External applications may also use the services of a social networking system to allow authenticated users to perform some of the above social interactions. Based on their historical interactions described above, social networking systems contain information about users' interests.

Social networking systems benefit from encouraging users to participate more actively, including by interacting with other users. There are a great many contexts in which the social networking systems may wish to know the interests of a particular user. Generally, the social networking systems would like to be able to make a decision about what will be most interesting to a user so that the social networking systems can present options to the user that are likely to cause the user to take actions in the social networking systems. For example, the social networking systems may want to know what is interesting to a user when deciding what content or stories to put in the newsfeed, what advertisements a user is likely to click on when selecting advertisements to serve, or which applications a user is likely to use when suggesting an application to the user.

In the past, social networking systems have approached this problem by developing ways to compute a user's affinity for objects in the social networking systems environment, but these have been inflexible, one-size-fits-all approaches. For example, if an affinity function is a good measure of how much a user likes another user, it could be very accurate to choose pictures to show the user, but perhaps less accurate to determine whether to suggest that the user invite other users to join a group, since the user may not like groups. As a result, the viewing user may not feel engaged enough to continue using the system, and the user's activity on the social networking system may be diminished.

### SUMMARY

In a social networking system environment, many different processes may each benefit from having some measure of affinity for a user of the social networking system. The measure of affinity for a user may reflect the user's interest in other users, content, actions, advertisements, or any other objects in the social networking system. To address the needs of the various processes, each of which may request a measure of affinity for a user of the social networking system, embodiments of the invention provide a measure of affinity that is relevant to the particular process that requested the measure of affinity. In that way, each process receives a measure of affinity that is tailored for the different context in which the process will use the measure of affinity.

In one embodiment, a process running in a social networking environment requests a measure of affinity for a particular user from a module that implements an affinity function. The module computes the requested measure of affinity by combining (e.g., adding) a weighted set of predictor functions, where each predictor function predicts whether the user will perform a different action. The weights are provided by the process that requests the measure of affinity, which allows the requesting process to weight the predictor functions differently. In this sense, the affinity function is tunable by the requesting process for its own purpose.

The predictor functions may predict whether a user will perform a particular action based on the user's interest in the action. For example, a predictor function may be derived based on a user's historical activity. Additionally, the predictor function may include a decay factor that causes the strength of the signal provided by the user's historical activity to decay with time. The predictor functions may predict any number of actions, which may be within or outside of the social networking system. For example, these actions may include various types of a user's communications, such as messages, posting of content, and commenting on content; various types of a user's observation actions, such as viewing profiles of other connections and viewing photos and content posted by other connections; and various types of coincidence information about two or more users, such as being tagged in the same photograph, checked in at the same location, and attending the same event. A predictor function may be determined using a machine learning algorithms trained on historical activity and past user responses or data farmed from users by exposing them to various options and measuring responses.

### BRIEF DESCRIPTION OF THE DRAWINGS

FIG. 1 is a block diagram of an affinity function for computing a measure of affinity for users of a social networking system, in accordance with an embodiment of the invention.

FIG. 2 is a block diagram of a social networking system, in accordance with an embodiment of the invention.

FIG. 3 is a flow chart of a method for computing a measure of affinity for a user of a social networking system, in accordance with an embodiment of the invention.

FIG. 4 is an interaction diagram of a method in which multiple processes obtain different measures of affinity for a user, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

An online social networking system allows users to associate themselves and establish connections with other users of the social networking system. When two users become connected, they are said to be “connections,” “friends,” “contacts,” or “associates” within the context of the social networking system. Generally being connected in a social networking system allows connected users access to more information about each other than would otherwise be available to unconnected users. Likewise, becoming connected within a social networking system may allow a user greater access to communicate with another user, such as by email (internal and external to the social networking system), instant message, text message, phone, or any other communicative interface. Finally, being connected may allow a user access to view, comment on, download or endorse another user's uploaded content items. Examples of content items include but are not limited to messages, queued messages (e.g., email), text and SMS (short message service) messages, comment messages, messages sent using any other suitable messaging technique, an HTTP link, HTML files, images, videos, audio clips, documents, document edits, calendar entries or events, and other computer-related files.

Users of social networking systems may interact with objects such as content items, user information, user actions (for instance communication made within the social networking system, or two users becoming connections), or any other activity or data within the social networking system. This interaction may take a variety of forms, such as by communicating with or commenting on the object; clicking a button or link associated with affinity (such as a “like” button); sharing a content item, user information or user actions with other users; downloading or merely viewing a content item; or by any other suitable means for interaction. Users of a social networking system may also interact with other users by connecting or becoming friends with them, by communicating with them, or by having common connections within the social networking system. Further, a user of a social networking system may form or join groups, or may become a fan of a fan page. Finally, a social networking system user may interact with content items, websites, other users or other information outside of the context of the social networking system's web pages that are connected to or associated with the social networking system. For instance, an article on a news web site might have a “like” button that users of the social networking system can click on to express approval of the article. These interactions and any other suitable actions within the context of a social networking system may be recorded in social networking system data, which can be used to generate measures of affinity which predict the likely actions will take in a given situation. The predictions could then be used to encourage more user interaction with the social networking system and enhance the user experience.

The social networking system maintains a user profile for each user. Any action that a particular member takes with respect to another member is associated with each user's profile, through information maintained in a database or other data repository. Such actions may include, for example, adding a connection to the other member, sending a message to the other member, reading a message from the other member, viewing content associated with the other member, attending an event posted by another member, among others. The user profiles also describe characteristics, such as work experience, educational history, hobbies or preferences, location or similar data, of various users and include data describing one or more relationships between users, such as data indicating users having similar or common work experience, hobbies or educational history. Users can also post messages specifically to their profiles in the form of status updates. Users of a social networking system may view the profiles of other users if they have the permission. In some embodiments, becoming a connection of a user automatically provides the permission to view the user's profile.

The social networking system also attempts to deliver the most relevant information to a viewing user employing algorithms to filter the raw content on the network. Content may be filtered based on the attributes in a user's profile, such as geographic location, employer, job type, age, music preferences, interests, or other attributes, as well as based on the interests of the user with respect to another user who is related to the generated content (e.g., the user who performed an action that resulted in the content or information). Newsfeed stories may be generated to deliver the most relevant information to a user based on a ranking of the generated content, filtered by the user's affinity, or attributes. Similarly, social endorsement information may be used to provide social context for advertisements that are shown to a particular viewing user.

The social networking system also provides application developers with the ability to create applications that extend the functionality of the social networking system to provide new ways for users to interact with each other. For example, an application may provide an interesting way for a user to communicate with other users, or allow users to participate in multi-player games, or collect some interesting information such as news related to a specific topic and display it to the member periodically. To the applications, the social networking system resembles a platform.

To predict the likely actions a user may take in a given situation, any process on the social networking system or outside may request a measure of affinity for a user by providing a set of weights. The measure of affinity may reflect the user's interest in other users, content, actions, advertisements, or any other objects in the social networking system. The weights may be binary or, more generally, any real number.

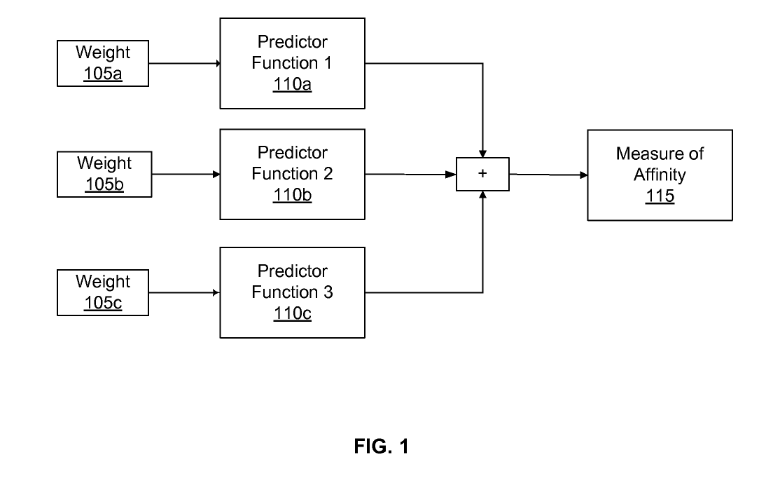

FIG. 1 is a block diagram of a function for computing a measure of affinity for users in a social networking system. To compute a measure of affinity 115 that indicates a set of likely actions a user may want to take in any given situation, weights 105 are applied to predictor functions 110 and then combined to obtain a measure of affinity 115. Although FIG. 1 shows three predictor functions 110, any number of predictor functions can be employed in other embodiments of the invention.

Additionally, in the embodiment of FIG. 1, the weighted predictor functions 110 are combined linearly. In different embodiments, other forms of combination may be used, including harmonic means, mean squares, and geometric means. Additionally, multiple measures of affinity 115 with varying weights 105 may be computed before predicting a user's actions.

The weights 105 of the affinity function enable it to be used by various processes in the social networking system environment for different purposes. For example, in a process that provides advertisements with social endorsements from a viewer's friends, an ad algorithm may use the measure of affinity 115 function to determine which of a user's connections to mention in the social endorsement or what type of actions to mention in the endorsement. The measure of affinity 115 may then be based on those predictor functions 110 that show how interested the user is in viewing the content posted by another user as well as one or more predictor functions 110 that show how interested the user is in various actions that may be mentioned in the social endorsement. The ad algorithm would thus provide relatively large weights for these predictor functions 110 so that the resulting measure of affinity would more accurately determine which social endorsements would be more interesting to the viewing user. The ad algorithm would then select the social endorsement using the resulting measure of affinity, thereby increasing the likelihood of conversion of the advertisement.

As a second example, in a process for a social game application that seeks to invite connections of the user or send messages on behalf of the user, a social algorithm may use the measure of affinity 115 function to determine which of a user's connections to suggest for invitation to the game or what type of messages to send on behalf of the user. The measure of affinity 115 for this purpose may be based on predictor functions 110 that show how interested the user is in viewing the content posted by the user's connections and/or how often the users plays games with the user's connections in general, as well as one or more predictor functions 110 that show how interested the user is posting different types of messages. Accordingly, the social algorithm would weight these predictor functions 110 relatively high so that the resulting measure of affinity would accurately determine which connection(s) to suggest that the user invite and which invitations or messages would be more interesting to the viewing user, and then select the invitation or message using the resulting measure of affinity. Because of the highly tunable nature of the affinity function, enabled by the weighted predictor functions 110, it can be used for a number of different purposes.

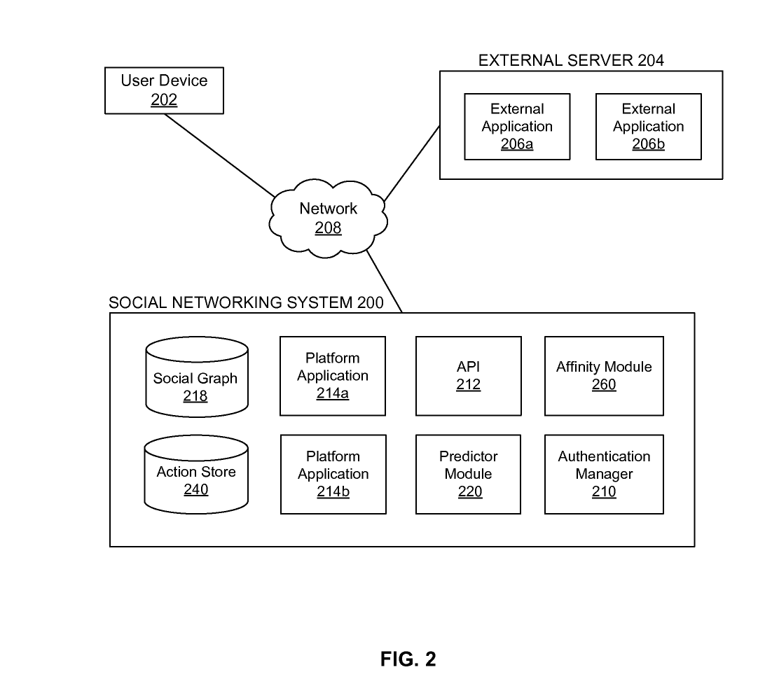

FIG. 2 is a high-level block diagram of an environment of a social networking system, according to one embodiment. FIG. 2 illustrates a social networking system 200, a user device 202, and an external server 204 connected by a network 208.

A user interacts with the social networking system 200 using a user device 202, such as a personal computer or a mobile phone. The user device 202 may communicate with the social networking system 200 via an application such as a web browser or native application. Typical interactions between the user device 202 and the social networking system 200 include operations such as viewing profiles of other users of the social networking system 200, contributing and interacting with media items, joining groups, listing and confirming attendance at events, checking in at locations, liking certain pages, creating pages, and performing other tasks that facilitate social interaction.

The social networking system 200 comprises a number of components used to store information about its users and objects represented in the social networking environment, as well as the relationships among the users and objects. The social networking system 200 additionally comprises components to enable several actions to user devices of the system, as described above.

The social graph 218 stores the connections that each user has with other users of the social networking system 200. The social graph 218 may also store second-order connections, in some embodiments. The connections may thus be direct or indirect. For example, if user A is a first-order connection of user B but not of user C, and B is a first-order connection of C, then C is a second-order connection of A on the social graph 218.

The action store 240 stores actions that have been performed by the users of the social networking system 200, along with an indication of the time associated with those actions and references to any objects related to the actions. Additionally, the action store 240 may store statistics for specified categories of actions. For example, for a given user the action store 240 may contain the number of wall posts in 30 days by a user, number of photos posted by the user in 30 days and number of distinct users that received the user's comments in 30 days. For a given connection between two users, user A and user B, the action store may contain actions such as the number of profile page views from A to B, the number of photo page views from A to B, and the number of times A and B were tagged in the same photo, and these actions may be associated with a timestamp or may be filtered by a cutoff (e.g., 24 hours, 90 days, etc.). The actions recorded in the action store 240 may be farmed actions, which are performed by a user in response to the social networking system 200 providing suggested choices of actions to the user.

The predictor module 220 is responsible for computing a set predictor functions 110, which predict whether a user will perform a set of corresponding actions. As discussed above, each predictor function 110 may be representative of a user's interest in a particular action associated with the predictor function 110. The historical activity of a user may be used as a signal of a user's future interest in the same activity. In some embodiments, the predictor function 110 is generated using a machine learned algorithm that is trained using a user's historical activity associated with an action. The predictor module 220 thus provides a predictor function 110 for each of a set of actions, where a predictor function 110 may take as an input the a user's historical activity and then outputs a measure of the likelihood that the user will engage in the corresponding activity.

In some embodiments, one or more of the predictor functions 110 may use a decay factor in which the strength of the signal from a user's historical activity decays with time. Moreover, different predictor functions 110 may decay the historical activity at different rates. For example, some types of user activity, like adding a new connection, indicate a more persistent interest than other types of activity that indicate a more ephemeral interest, like commenting on another user's status. Therefore, the predictor functions 110 may decay the effect of historical activity based on an understanding about how that activity may become less relevant over the passage of time. Various decay mechanisms may be used for this purpose. For example, a predictor function 110 may use a mathematical function, such as an exponential decay, to decay the statistics about a user behavior. In another embodiment, the decay is implemented by selecting only those statistics about a user behavior that occurred within a specific window of time, such as 24 hours or 30 days.

In one embodiment, a predictor function 110 is realized as a ratio of two affine functions as shown in equation (1). The numerator and denominator affine functions take statistics of the user's historical activity as inputs.

$$P = \frac{{a}_{0} + {a}_{1} {x}_{1} + {a}_{2} {x}_{2} + … + {a}_{N} {x}_{N}}{{b}_{0} + {b}_{1} {x}_{N + 1} + … + {b}_{M} {x}_{N + M}} \qquad ( 1 )$$

where
P is the predictor function 110;
aᵢ for i=0, 1, 2, . . . , N are the coefficients in the numerator affine function;
bᵢ for i=0, 1, 2, . . . , M are the coefficients in the denominator affine function; and
xᵢ for i=1, 2, . . . , N+M are the statistics on a user's historical activity related to the predictor function P.
   The denominator affine function can represent a normalization of the numerator affine function. For example, the number of comments made by a user may be normalized by, among other statistics, the number of times the user has been active on the social networking system 200. In particular, by altering bᵢ for i=0, 1, 2, . . . , M the normalization pattern can be changed.

In some embodiments, some or all of the coefficients, aᵢ for i=0, 1, 2, . . . , N and bᵢ for i=0, 1, 2, . . . , M, are determined through machine learning, which may be implemented by the predictor module 220. In a particular embodiment, a supervised machine learning algorithm is used with the training data obtained through farming, by providing a statistically significant number of users several options and monitoring their response. In another embodiment, the supervised machine learning algorithm is trained entirely based on historical user activity and past responses to choices of actions.

The predictor functions 110 may also be non-linear. An exemplary embodiment implements a predictor function 110 for a family where the predictor function 110 includes an ‘if-then’ construct for the members of the family—i.e., the predictor function 110 is computed differently depending on whether it is being computed for the parents or the children.

Some predictor functions 110 in the social networking system 200 may predict actions related to a user's communication in the social networking system 200. The statistics specifically related to communications may include broadcast data and communication data. Broadcast data may include, for example, the number of photos posted by the user in a given time period, the number of posts via applications by the user in a given time period, and any other communication that the user has posted or otherwise distributed to a group of other users. Communication data may include, for example, the number of likes from the user in a given time period, number of comments posted by user in a given time period, and any other information about the user's communication activities.

Similarly, some predictor functions 110 in the social networking system 200 may predict actions related to a user's observation of content in the social networking system 200. The statistics specifically related to observation may include, for example, the number of profile page views by the user of another user in a given time period, the number of photo views by the user in a given time period, the number of views of an advertisement containing a social endorsement in a given time period, and any other activity involving the viewing of content by the user.

Finally, some predictor functions 110 in the social networking system 200 may predict actions related to a user's coincidence with one or more other users of the social networking system. The statistics specifically related to coincidence may include, for example, a rate at which two or more users have been tagged in the same photograph, have checked in at the same location, or have confirmed (e.g., via RSVP) that they will be attending the same event, and any other activity involving an action or object in the social networking system related to multiple users.

The affinity module 260 provides a measure of affinity 115 based on input data about the user from the social networking system 200 using the predictor functions 110. In the embodiment of FIG. 1, the affinity module 260 sums the predictor functions linearly as shown in equation (2). However, other implementations are equally feasible.

A=β₀+β₁P₁+β₂P₂+ . . . +βₛPₛ (2)
where
A is the measure of affinity 115 requested;
Pᵢ for i=0, 1, 2, . . . , s are the s predictor functions 110 in the social networking system 200; and
βₜ for i=1, 2, . . . , s are the weights 105 assigned to the s predictor functions 110 in the social networking system 200.

The authentication manager 210 authenticates a user on user device 202 as being a registered user of the social networking system 200. The authentication manager 210 may allow a user to log into the social networking system 200 from any user device 202 that has an application supporting the social networking system 200. The application programming interface (API) 212 works in conjunction with the authentication manager 210 to validate users via external applications 206 described below.

Various different processes may request a measure of affinity from the affinity module 260. For example, the processes may include those that implement basic social networking system functionality, such as newsfeed algorithms, ad targeting algorithms, and friend suggestion algorithms, among many others. Other processes that request measures of affinity may be executed by one or more platform applications 214, which are applications that operate within the social networking system 200 but may be provided by third parties other than an operator of the social networking system 200. Platform applications 214 may include social games, messaging services, and any other application that uses the social platform provided by the social networking system 200. In some embodiments, the processes requesting a measure of affinity for a user may include one or more external applications 206 running on an external server 204. The external applications 206 may interact with the social networking system 200 via API 212. The external applications 206 can perform various operations supported by the API 212, such as enabling users to send each other messages through the social networking system 200 or showing advertisements routed through the social networking system 200.

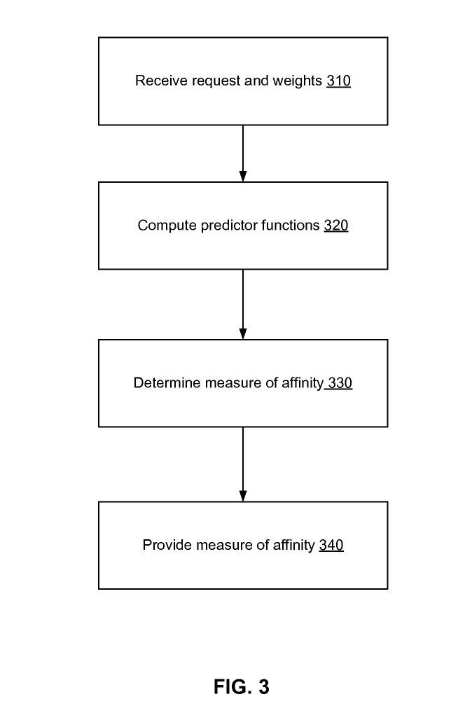

FIG. 3 illustrates an embodiment of a method for computing a measure of affinity 115 for a user based on a request. The social networking system 200 first receives 310 a request from a process for a measure of affinity 115 for a user along with the weights 105 to be assigned to the various predictor functions 110. The social networking system 200 then computes 320 the predictor functions 110 for the user in the predictor module 220. The predictor functions 110 previously computed are combined to determine 330 an overall measure of affinity 115, which is then provided 340 to the requesting process.

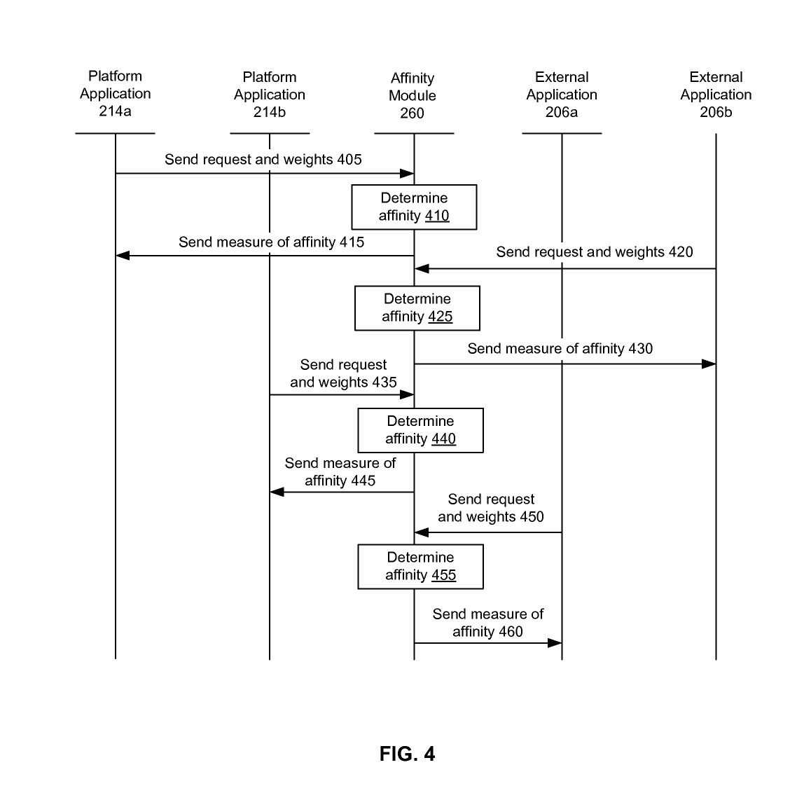

FIG. 4 illustrates an embodiment of a method in which the affinity module 260 handles requests from multiple processes to predict different user actions using measures of affinity 115 that may be computed using different sets of weights. As illustrated, platform application 214a sends a request for a measure of affinity 115 for a given user to the affinity module 260, which then determines 410 the affinity and sends 415 it back to the platform application 214a. Platform application 214b and external applications 206a and 206b also perform similar actions with the affinity predictor for the same user. However, each of the platform application 214a, platform application 214b, external application 206a, and external application 206b may provide different sets of weights. Moreover, each requesting process may provide different weights for subsequent requests, thereby obtaining different measures of affinity for different purposes. In this way, each time a process requests a measure of affinity from the affinity module 260, the requesting process can obtain a measure of affinity that is tuned for the particular type of activity with which the requesting process is interested.

In one example of the situation shown in FIG. 4, platform application 214a could be a social game that needs to know which of a user's connections to show in a leader board, and platform application 214b could be a media aggregation application that needs to decide whether to give a user the option of posting media content or commenting on media content posted by connections. Similarly, external application 206a could be a plug-in for an external website that needs to determine whether to show a user the option of liking content posted by connections or sharing the content with the user's connections, and external application 206b could be an game hosted by the external server 204 that needs to select which of a user's connections to suggest that the user invite to play the game. Each of these processes may tune the affinity function for its unique purposes by providing appropriate weights for the predictor functions 110 (which may be determined by an application developer), as described above.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for providing a measure of affinity for a user of a social networking system, the method comprising:
receiving a request for a measure of affinity for a user of a social networking system from a process, the request specifying one or more weights related to a plurality of actions in the social networking system;
weighting each of a plurality of predictor functions using the received weights, wherein each predictor function predicts whether the user will perform an action associated with the weight applied thereto;
computing a measure of affinity for the user by combining the weighted plurality of predictor functions; and
providing the computed measure of affinity to the process.

2. The method of claim 1, wherein computing the measure of affinity for the user involves linearly combining the weighted set of predictor functions.

3. The method of claim 1, wherein the weights specified in the request are binary.

4. The method of claim 1, wherein the action is representative of a user's communication in the social networking system.

5. The method of claim 1, wherein the action is representative of a user's observation of content in the social networking system.

6. The method of claim 1, wherein the action is representative of two or more users' coincidence in the social networking system.

7. The method of claim 1, wherein the action is selected from a group consisting of: commenting on a content item, using a third party application, inviting a connection to perform an activity, playing a game, and expressing an affinity for an object in the social networking system.

8. The method of claim 1, wherein the predictor function predicts whether the user will perform an action associated with the weight based on the user's interest in the action.

9. The method of claim 1, wherein the predictor function predicts whether the user will perform an action associated with the weight based on the user's historical activity.

10. The method of claim 1, wherein the predictor functions are determined as functions of statistics on user's historical activity.

11. The method of claim 10, wherein the functions of statistics on user's historical activity implement time decay by assigning recent activity higher relative importance.

12. The method of claim 10, wherein the functions of statistics in the predictor functions are determined through machine learning algorithms.

13. The method of claim 1, wherein each of the plurality of predictor functions are determined as a ratio of a numerator affine function of statistics on user's historical activity and a denominator affine function of statistics on user's historical activity.

14. The method of claim 13, wherein the denominator affine function of statistics on user's historical activity represents a normalization of the numerator affine function of statistics on user's historical activity.

15. A method for obtaining a prediction of an action of a user of a social networking system, the method comprising:
sending a request for a measure of affinity for a user of a social networking system from a process, the request specifying one or more weights related to a first plurality of actions in the social networking system;
receiving the measure of affinity computed by combining a plurality of predictor functions corresponding to the first plurality of actions; and
predicting a second plurality of actions the user will perform in the process according to the received measure of affinity.

16. The method of claim 15, wherein the process is executed within the social networking system.

17. The method of claim 15, wherein the process is executed by a server external to the social networking system.

18. The method of claim 15, wherein the process is performed by a platform application provided by third party and executed within the social networking system.

19. The method of claim 15, wherein the action comprises a user's communication to another user in the social networking system.

20. The method of claim 15, wherein the action comprises a user's observation of content in the social networking system.

21. The method of claim 15, wherein the action is selected from a group consisting of: commenting on a content item, using a third party application, inviting connections to perform an action, playing a game, and expressing an affinity for an object in the social networking system.
